(19) United States
(12) Patent Application Publication
(10) Pub. No.: US 2021/0373353 A1
(43) Pub. Date: Dec. 2, 2021

(54) LENS DRIVING DEVICE, CAMERA DEVICE, AND ELECTRONIC APPARATUS

(71) Applicant: New Shicoh Motor Co., Ltd., Zhejiang (CN)

(72) Inventor: Kazuyoshi Hagiwara, Kanagawa (JP)

(21) Appl. No.: 17/082,889

(22) Filed: Oct. 28, 2020

(30) Foreign Application Priority Data
May 28, 2020 (CN) 202010468527.2

(51) Int. Cl. G02B 27/64; G03B 5/00

(52) U.S. Cl. CPC G02B 27/646; G03B 2205/0007; G03B 5/00

(57) ABSTRACT

A lens driving device, a camera device, and an electronic apparatus, which are capable of ensuring smooth movement of a lens support wherein the lens driving device includes: a lens support; a frame member; and a guide mechanism configured to guide the lens support in such a manner that the lens support is freely movable in a direction orthogonal to an optical axis direction of the lens relative to a predetermined member forming the frame member. The guide mechanism includes, on each of one side and another side in a direction orthogonal to a moving direction of the lens support: a guide protrusion which extends along the moving direction of the lens support, and protrudes in the optical axis direction; and a guide groove formed in such a manner as to recess in the optical axis direction to allow the guide protrusion to be fitted to the guide groove. When viewed from the direction in which the guide protrusion and the guide groove extend, the guide protrusion and the guide groove are brought into line contact with each other at two positions on the one side in the direction orthogonal to the moving direction of the lens support, and are brought into surface contact with each other on the another side.

### BACKGROUND OF THE INVENTION

### 1. Field of the Invention

The present invention relates to a lens driving device, a camera device, and an electronic apparatus.

### 2. Description of the Related Art

A small-sized camera device is mounted on an electronic apparatus, e.g. , a mobile phone or a smart phone. As this type of small-sized camera, for example, as disclosed in US 2015/049209, there is known a small-sized camera having an image stabilization function.

In US 2015/049209, a camera module includes a lens support configured to support a lens, and a frame member surrounding the lens support. In order to support the lens support so as to be freely movable in a direction orthogonal to an optical axis direction of the lens relative to the frame member, a plurality of balls are used. Further, the above-mentioned camera module includes a magnet and a magnetic member provided so as to be opposed to the magnet. An attraction force generated between the magnet and the magnetic member causes the balls to be sandwiched between the lens support and the frame member.

However, when a force larger than the attraction force between the magnet and the magnetic member is applied due to, for example, falling, the lens support may be separated from the balls, and then the lens support may hit the balls again. As a result, the lens support and the frame member that are brought into point contact with the balls receive the impact, and thus there have been problems in that a dent or a crack may occur in a ball hitting part and smooth movement of the lens support may not be ensured.

### SUMMARY OF THE INVENTION

The present invention has been made to solve the above-mentioned problems in the related art, and has an object to provide a lens driving device, a camera device, and an electronic apparatus, which are capable of ensuring smooth movement of a lens support.

One aspect of the present invention is a lens driving device. The lens driving device includes: a lens support configured to support a lens; a frame member configured to support the lens support; and a guide mechanism configured to guide the lens support in such a manner that the lens support is freely movable in a direction orthogonal to an optical axis direction of the lens relative to a predetermined member forming the frame member. The guide mechanism includes, on each of one side and another side in a direction orthogonal to a moving direction of the lens support: a guide protrusion which extends along the moving direction of the lens support, and protrudes in the optical axis direction; and a guide groove formed in such a manner as to recess in the optical axis direction to allow the guide protrusion to be fitted to the guide groove. When viewed from the direction in which the guide protrusion and the guide groove extend, the guide protrusion and the guide groove are brought into line contact with each other at two positions on the one side in the direction orthogonal to the moving direction of the lens support, and are brought into surface contact with each other on the another side.

Preferably, the guide mechanism includes: a first guide mechanism provided on one side in the optical axis direction; and a second guide mechanism provided on another side in the optical axis direction, and at least one of the first guide mechanism or the second guide mechanism includes the guide protrusion and the guide groove.

Preferably, the guide protrusion and the guide groove of the first guide mechanism extend in a first direction orthogonal to the optical axis direction, and when viewed from the first direction, the guide protrusion and the guide groove are brought into line contact with each other at two positions on one side in a second direction orthogonal to both the optical axis direction and the first direction and are brought into surface contact with each other on another side, and the guide protrusion and the guide groove of the second guide mechanism extend in the second direction, and when viewed from the second direction, the guide protrusion and the guide groove are brought into line contact with each other at two positions on one side in the first direction and are brought into surface contact with each other on another side.

Preferably, on the side on which the guide protrusion and the guide groove are brought into line contact with each other, when viewed from the direction in which the guide protrusion and the guide groove extend, the guide groove has such a shape that a width of the guide groove decreases toward a groove bottom, and a space is defined between the guide protrusion and the guide groove in a region between the groove bottom and each of the two positions of the line contact, and, on the side on which the guide protrusion and the guide groove are brought into surface contact with each other, when viewed from the direction in which the guide protrusion and the guide groove extend, the guide groove has, at a groove bottom thereof, a flat surface extending in a direction orthogonal to the direction in which the guide protrusion and the guide groove extend, and the guide protrusion has a flat surface brought into surface contact with the flat surface of the guide groove.

Preferably, the lens support has, on the side on which the guide protrusion and the guide groove are brought into line contact with each other, one of a magnet and a magnetic member arranged parallel to the direction in which the guide protrusion and the guide groove extend, and the frame member has another one of the magnet and the magnetic member arranged in such a manner as to be opposed to the one of the magnet and the magnetic member.

Preferably, the frame member is configured to move, together with the lens support, in the optical axis direction.

Another aspect of the present invention is a camera device. The camera device includes: the lens driving device of any one of the above aspects; and a lens supported by the lens support.

Another aspect of the present invention is an electronic apparatus. The electronic apparatus includes the camera device of the above aspect.

According to the present invention, the guide protrusion and the guide groove are arranged on each of one side and another side in the direction orthogonal to the optical axis direction of the lens and extend along the moving direction of the lens support. The guide protrusion and the guide groove are brought into line contact with each other at two positions on the one side in the direction orthogonal to the optical axis direction and are brought into surface contact with each other on the another side. Therefore, in the lens driving device according to the present invention, impact received in the optical axis direction can be reduced, and positioning of the guide protrusion and the guide groove can be performed accurately, thereby being capable of ensuring smooth movement of the lens support.

### BRIEF DESCRIPTION OF THE DRAWINGS

FIG. 1 is an exploded perspective view for illustrating a camera device 10 according to an embodiment of the present invention in a disassembled state as viewed obliquely from above.

FIG. 2 is an exploded perspective view for illustrating a moving body 18 forming the camera device 10 of FIG. 1 in a disassembled state as viewed obliquely from above.

FIG. 3 is an exploded perspective view for illustrating the moving body 18 of FIG. 2 as viewed obliquely from below.

FIG. 4 is an exploded perspective view for illustrating apart of a fixed body 16 used in the camera device 10 according to the embodiment of the present invention as viewed obliquely from above.

FIG. 5 is a perspective view for illustrating a flexible printed board 78 mounted to the fixed body 16 of FIG. 4.

FIG. 6 is a plan view for illustrating the moving body 18 of FIG. 2 as viewed from above.

FIG. 7A is a sectional view for illustrating the moving body 18, which is taken along the line VIIA-VIIA of FIG. 6.

FIG. 7B is a sectional view for illustrating the moving body 18, which is taken along the line VIIB-VIIB of FIG. 6.

FIG. 8A is an enlarged sectional view for illustrating the portion VIIIA of FIG. 7A.

FIG. 8B is an enlarged sectional view for illustrating the portion VIIIB of FIG. 7A.

FIG. 9A is an enlarged sectional view for illustrating the portion IXA of FIG. 7B.

FIG. 9B is an enlarged sectional view for illustrating the portion IXB of FIG. 7B.

FIG. 10 is an enlarged plan view for illustrating an optical axis-direction guide mechanism 102 in the embodiment as viewed from above.

FIG. 11 is a perspective view for illustrating a lens support in the embodiment as viewed obliquely from below.

FIG. 12 is a plan view for illustrating the lens support in the embodiment as viewed from above.

FIG. 13A is a sectional view for illustrating a lens-support forming mold in the embodiment, which is taken along the line XIIA of FIG. 12, and is an illustration of a state in which a resin is injected.

FIG. 13B is a sectional view for illustrating the lens-support forming mold in the embodiment, which is taken along the line XIIB of FIG. 12, and is an illustration of a state in which a resin is injected.

FIG. 14A is a sectional view for illustrating a lens-support forming mold in another embodiment, which is taken along the line XIIA of FIG. 12, and is an illustration of a state in which a resin is injected.

FIG. 14B is a sectional view for illustrating the lens-support forming mold in the another embodiment, which is taken along the line XIIB of FIG. 12, and is an illustration of a state in which a resin is injected.

### DESCRIPTION OF THE EMBODIMENTS

One embodiment of the present invention is described with reference to the drawings. In the embodiment described below, a lens driving device, a camera device, and an electronic apparatus according to the present invention are illustrated as examples. However, there is no intention to limit the present invention to the embodiment described below.

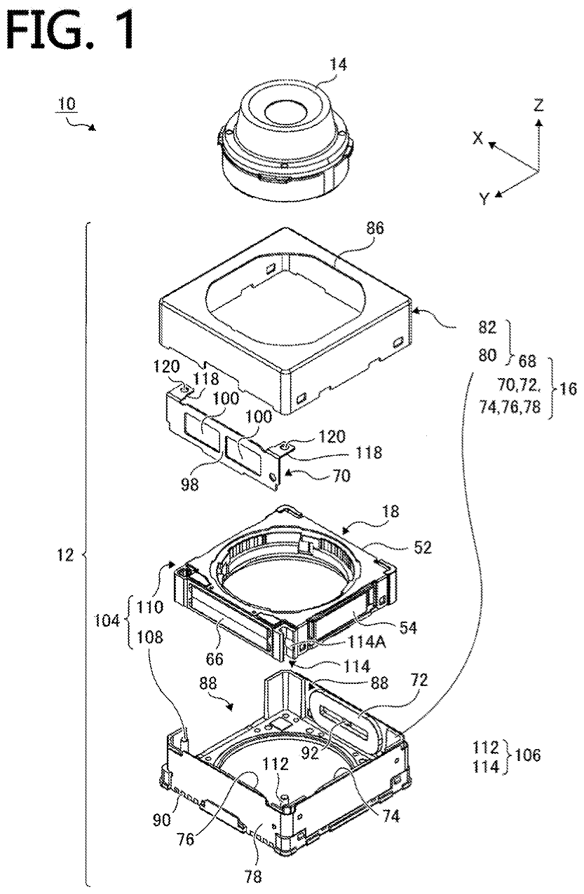

FIG. 1 is an illustration of a camera device 10 according to the embodiment of the present invention. The camera device 10 is to be mounted on an electronic apparatus, e.g., a mobile phone or a smart phone, and includes a lens driving device 12 and a lens 14 mounted to the lens driving device 12.

In the following description, for the sake of convenience, an optical axis direction of the lens 14 is referred to as “Z direction”, one direction orthogonal to the Z direction is referred to as “X direction”, and a direction orthogonal to both the Z direction and the X direction is referred to as “Y direction”. Further, an object side of an optical axis (corresponding to an upper side in FIG. 1) is referred to as “upper side”, and a side which is opposite to the upper side and on which an image sensor (not shown) is to be arranged is referred to as “lower side”.

The lens driving device 12 includes a fixed body 16 and a moving body 18 supported so as to be freely movable in the optical axis direction relative to the fixed body 16. The moving body 18 is arranged inside the fixed body 16.

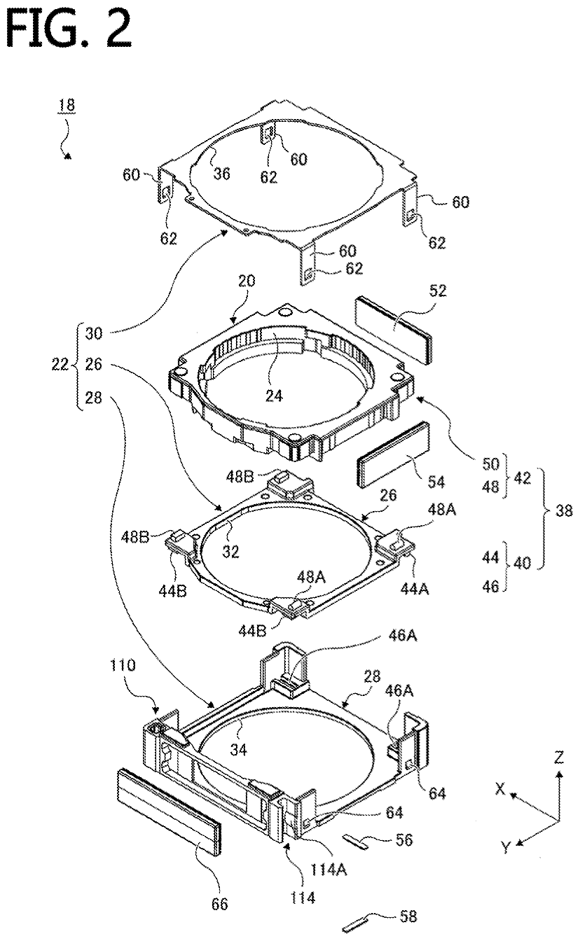

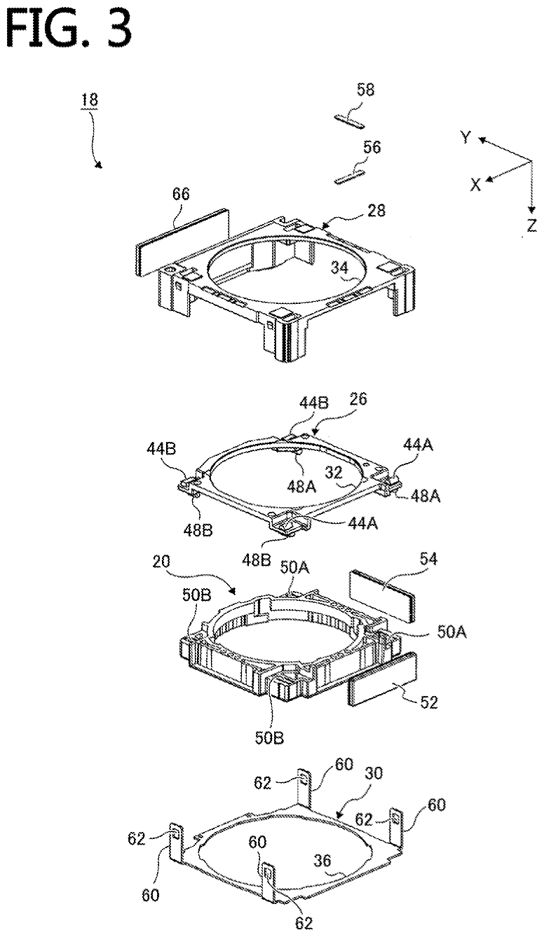

As illustrated in FIG. 2 and FIG. 3, the moving body 18 includes a lens support 20 and a first frame member 22. The lens support 20 is configured to support the lens 14. The first frame member 22 is a frame member surrounding the lens support 20. The lens support 20 and the first frame member 22 each have a substantially quadrangular outer shape as viewed from above.

The lens support 20 has a lens mounting hole 24 formed on an inner side thereof. The lens mounting hole 24 has a circular shape as viewed from the Z direction and is formed in such a manner as to pass through the lens support 20 from the upper side toward the lower side. The lens 14 is mounted to the lens mounting hole 24.

The first frame member 22 includes a first moving body plate 26, a second moving body plate 28, and a first cover 30, each of which has a substantially quadrangular outer shape as viewed from above. The lens support 20, the first moving body plate 26, and the second moving body plate 28 are each formed of engineering plastics such as liquid crystal polymer (LCP), polyacetal, polyamide, polycarbonate, modified polyphenylene ether, and polybutylene terephthalate. The first cover 30 is formed of, for example, a metal. The first moving body plate 26, the second moving body plate 28, and the first cover 30 have openings 32, 34, and 36, respectively, for allowing light to pass therethrough. The openings 32, 34, and 36 are formed in such a manner as to pass through the first moving body plate 26, the second moving body plate 28, and the first cover 30, respectively, from the upper side toward the lower side. The openings 32, 34, and 36 each have a substantially circular shape.

The first frame member 22 supports the lens support 20 in such a manner that the lens support 20 is freely movable in both the X direction, which is a first direction, and the Y direction, which is a second direction. Specifically, an orthogonal-direction guide mechanism 38, which is a guide mechanism, is provided to the lens support 20 and the first frame member 22, and is configured to support the lens support 20 in such a manner that the lens support 20 is freely movable in both the X direction and the Y direction relative to the second moving body plate 28, which is a predetermined member forming the frame member. The orthogonal-direction guide mechanism 38 includes a first guide mechanism 40 and a second guide mechanism 42. The first guide mechanism 40 is provided on one side (lower side) in the Z direction. The second guide mechanism 42 is provided on another side (upper side) in the Z direction.

The first guide mechanism 40 includes lower guide protrusions 44 and lower guide grooves 46. The lower guide protrusions 44 are formed on a lower surface of the first moving body plate 26 in such a manner as to protrude in the −Z direction from the lower surface of the first moving body plate 26. The lower guide grooves 46 are formed in an upper surface of the second moving body plate 28 in such a manner as to recess in the −Z direction to allow the lower guide protrusions 44 to be fitted to the lower guide grooves 46. The lower guide protrusions 44 and the lower guide grooves 46 are formed in the vicinity of respective four corner portions of the first moving body plate 26 and the second moving body plate 28 and each extend along the X direction.

The lower guide protrusions 44 and the lower guide grooves 46 each extend in the X direction. Therefore, the lower guide protrusions 44 and the lower guide grooves 46 are movable relative to each other only in the X direction, and movement in the Y direction is regulated. Thus, the first moving body plate 26 is movable only in the X direction relative to the second moving body plate 28, and movement in the Y direction is regulated. That is, the first guide mechanism 40 allows the lens support 20, together with the first moving body plate 26, to move in the X direction relative to the second moving body plate 28.

Further, the lower guide protrusions 44 and the lower guide grooves 46 are arranged on each of one side and another side in the Y direction, which is a direction orthogonal to the direction in which the first moving body plate 26 moves. Specifically, the lower guide protrusions 44 include two lower guide protrusions 44A and 44A, which are provided on the one side in the Y direction (−Y side), and two lower guide protrusions 44B and 44B, which are provided on the another side in the Y direction (+Y side) . Further, the lower guide grooves 46 include two lower guide grooves 46A and 46A, which are provided on the one side in the Y direction, and two lower guide grooves 46B and 46B, which are provided on the another side in the Y direction.

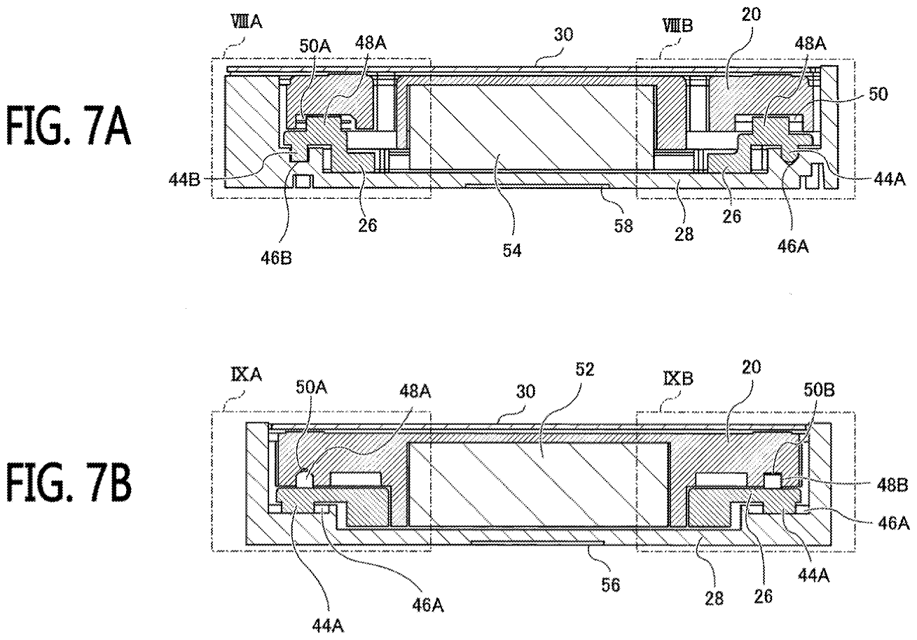

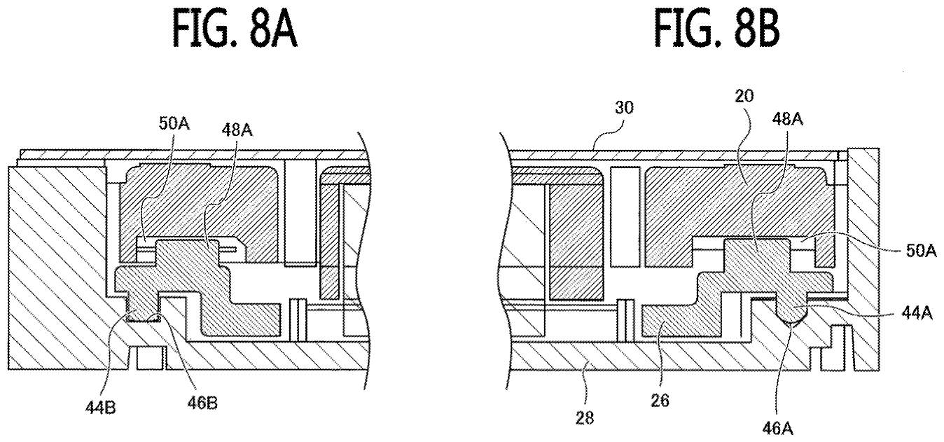

As illustrated in FIG. 7A and FIG. 8B, when viewed from the X direction, the lower guide grooves 46A and 46A on the one side in the Y direction each have a V-shaped cross section, that is, such a sectional shape that a width of each of the lower guide grooves 46A and 46A decreases toward a groove bottom, and are each inclined so as to be narrower toward the groove bottom. Further, the lower guide protrusions 44A and 44A each have a semicircular cross section. With this, an arc-shaped portion of each of the lower guide protrusions 44A and 44A and a straight portion of each of the lower guide grooves 46A and 46A are brought into line contact with each other at two positions. A space is defined between each of the lower guide protrusions 44A and 44A and a corresponding one of the lower guide grooves 46A and 46A in a region between the groove bottom and each of the two positions of the line contact. The sectional shape of each of the lower guide protrusions 44A and 44A may be a rectangular shape. In that case, the sectional shape of each of the lower guide grooves 46A and 46A may be a V-shape or a U-shape. Through the line contact at two positions, positions of the lower guide protrusions 44A and 44A with respect to the lower guide grooves 46A and 46A in the Y direction are determined without deviation.

Further, as illustrated in FIG. 7A and FIG. 8A, when viewed from the X direction, the lower guide protrusions 44B and 44B and the lower guide grooves 46B and 46B on the another side in the Y direction each have a rectangular cross section. That is, the lower guide grooves 46B and 463 have, on respective groove bottoms, flat surfaces extending in a direction orthogonal to the direction in which the lower guide protrusions 44B and 44B and the lower guide grooves 46B and 46B extend, and the lower guide protrusions 44B and 44B have flat surfaces brought into surface contact with the flat surfaces of the lower guide grooves 46B and 46B. With this, the lower guide protrusions 44B and 44B and the lower guide grooves 46B and 46B are brought into surface contact with each other on the another side in the Y direction. With this, a height of the first moving body plate 26 in the Z direction with respect to the second moving body plate 28 can be determined. The flat surfaces of the lower guide grooves 46B and 46B are wider than the lower guide protrusions 44B and 44B. Therefore, even when a distance between the lower guide protrusions 44A and 44A and the lower guide protrusions 44B and 443 and a distance between the lower guide grooves 46A and 46A and the lower guide grooves 46B and 46B are different from each other due to an error in manufacture, assembly can be performed, and the first moving body plate 26 can be smoothly moved.

The second guide mechanism 42 includes upper guide protrusions 48 and upper guide grooves 50. The upper guide protrusions 48 are formed on an upper surface of the first moving body plate 26 in such a manner as to protrude in the +Z direction from the upper surface of the first moving body plate 26. The upper guide grooves 50 are formed in a lower surface of the lens support 20 in such a manner as to recess in the +Z direction to allow the upper guide protrusions 48 to be fitted to the upper guide grooves 50. The upper guide protrusions 48 and the upper guide grooves 50 are formed in the vicinity of respective four corner portions of the first moving body plate 26 and the lens support 20 and each extend along the Y direction.

The upper guide protrusions 48 and the upper guide grooves 50 each extend in the Y direction. Therefore, the upper guide protrusions 48 and the upper guide grooves 50 are movable relative to each other only in the Y direction, and movement in the X direction is regulated. This, the lens support 20 is movable only in the Y direction relative to the first moving body plate 26, and movement in the X direction is regulated. That is, the second guide mechanism 42 allows the lens support 20 to move in the Y direction relative to the first moving body plate 26. Combination of the second guide mechanism 42 with the first guide mechanism 40 allows the lens support 20 to move in the X direction and the Y direction relative to the second moving body plate 28. Further, the first guide mechanism 40 and the second guide mechanism 42 are guide mechanisms which are independent of each other. Therefore, even when the first guide mechanism 40 and the second guide mechanism 42 are simultaneously driven in the X-Y directions, a force in a rotating direction about the Z direction does not act, thereby being capable of preventing vibration of the lens support 20 in the rotating direction.

Further, the upper guide protrusions 48 and the upper guide grooves 50 are arranged on each of one side and another side in the X direction, which is a direction orthogonal to the direction in which the lens support 20 moves. Specifically, the upper guide protrusions 48 include two upper guide protrusions 48A and 48A, which are provided on the one side in the X direction (−X side), and two upper guide protrusions 48B and 48B, which are provided on the another side in the X direction (+X side) . Further, the upper guide grooves 50 include two upper guide grooves 50A and 50A, which are provided on the one side in the X direction, and two upper guide grooves 50B and 50B, which are provided on the another side in the X direction.

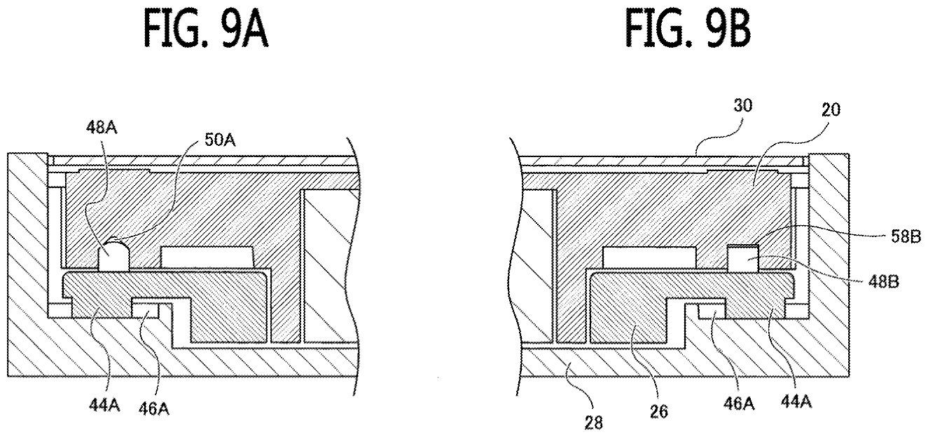

As illustrated in FIG. 7B and FIG. 9A, when viewed from the Y direction, the upper guide grooves 50A and 50A on the one side in the X direction each have a V-shaped cross section, that is, such a sectional shape that a width of each of the upper guide grooves 50A and 50A decreases toward a groove bottom, and are each inclined so as to be narrower toward the groove bottom. Further, the upper guide protrusions 48A and 48A each have a semicircular cross section. With this, an arc-shaped portion of each of the upper guide protrusions 48A and 48A and a straight portion of each of the upper guide grooves 50A and 50A are brought into line contact with each other at two positions. And a space is defined between each of the upper guide protrusions 48A and 48A and a corresponding one of the upper guide grooves 50A and 50A in a region between the groove bottom and each of the two positions of the line contact. The sectional shape of each of the upper guide protrusions 48A and 48A may be a rectangular shape. In that case, the sectional shape of each of the upper guide grooves 50A and 50A may be a V-shape or a U-shape. Through the line contact at two positions, positions of the upper guide grooves 50A and 50A with respect to the upper guide protrusions 48A and 48A in the X direction are determined without deviation.

Further, as illustrated in FIG. 7B and FIG. 9B, when viewed from the Y direction, the upper guide protrusions 48B and 48B and the upper guide grooves 50B and 50B on the another side in the X direction each have a rectangular cross section. That is, the upper guide grooves 50B and 50B each have, on respective groove bottoms, flat surfaces extending in a direction orthogonal to the direction in which the upper guide protrusions 48B and 48B and the upper guide grooves 50B and 50B extend, and the upper guide protrusions 48B and 48B have flat surfaces brought into surface contact with the flat surfaces of the upper guide grooves 50B and 508. With this, the upper guide protrusions 48B and 48B and the upper guide grooves 50B and 50B are brought into surface contact with each other on the another side in the X direction. With this, a height of the lens support 20 in the Z direction with respect to the first moving body plate 26 can be determined. The flat surfaces of the upper guide grooves 50B and 50B are wider than the upper guide protrusions 48B and 48B. Therefore, even when a distance between the upper guide protrusions 48A and 48A and the upper guide protrusions 48B and 4EB and a distance between the upper guide grooves 50A and 50A and the upper guide grooves 50B and 50B are different from each other due to an error in manufacture, assembly can be performed, and the lens support 20 can be smoothly moved.

A first magnet 52 and a second magnet 54 each having a plate shape is fixed on an outer side of the lens support 20. The first magnet 52 is arranged, with a plate surface thereof facing the Y direction, on the one side in the Y direction, that is, the side on which the lower guide protrusions 44A and 44A and the lower guide grooves 46A and 46A are in line contact with each other. The second magnet 54 is arranged, with a plate surface thereof facing the X direction, on the one side in the X direction, that is, the side on which the upper guide protrusions 48A and 48A and the upper guide grooves 50A and 50A are in line contact with each other. The first magnet 52 has an S pole provided on the one plate surface facing the Y direction and has an N pole provided on another plate surface. The second magnet 54 has an S pole provided on the one plate surface facing the X direction and has an N pole provided on another plate surface.

A first magnetic member 56 and a second magnetic member 58 each made of a magnetic material are arranged on a lower surface of the second moving body plate 28. The first magnetic member 56 is arranged along the X direction on the one side in the Y direction so as to be parallel to the first magnet 52. The second magnetic member 58 is arranged along the Y direction on the one side in the X direction so as to be parallel to the second magnet 54. Thus, the first magnetic member 56 is opposed to the first magnet 52 across the second moving body plate 28 in the Z direction, and similarly, the second magnetic member 58 is opposed to the second magnet 54 across the second moving body plate 28 in the Z direction.

On the one side in the Y direction, the first magnet 52 and the first magnetic member 56 are arranged between one pair of the lower guide protrusion 44A and the lower guide groove 46A and another pair of the lower guide protrusion 44A and the lower guide groove 46A and attract each other. Therefore, the lower guide protrusions 44A and 44A and the lower guide grooves 46A and 46A in line contact with each other are brought into contact with each other in a manner stronger than a case in which the first magnet 52 and the first magnetic member 56 are arranged at another position, thereby being capable of more accurately performing positioning in the Y direction.

On the one side in the X direction, the second magnet 54 and the second magnetic member 58 are arranged between one pair of the upper guide protrusion 48A and the upper guide groove 50A and another pair of the upper guide protrusion 48A and the upper guide groove 50A and attract each other. Therefore, the upper guide protrusions 48A and 48A and the upper guide grooves 50A and 50A in line contact with each other are brought into contact with each other in a manner stronger than a case in which the second magnet 54 and the second magnetic member 58 are arranged at another position, thereby being capable of more accurately performing positioning in the X direction.

At four corners of the first cover 30, mounting portions 60 are provided in such a manner as to extend downward in the Z direction. The mounting portions 60 each have a mounting hole 62 having a quadrangular shape. Further, at four corners of the second moving body plate 28, mounted portions 64 are formed in such a manner as to protrude sideward. The mounting holes 62 are fitted to the mounted portions 64. With this, the first cover 30 is fixed to the second moving body plate 28. As illustrated in FIG. 7A and FIG. 7B, between a lower surface of the first cover 30 and an upper surface of the lens support 20, there is defined a necessary minimum gap including an error caused by, for example, a tolerance. With this, even when impact is received, the lens support 20, the first moving body plate 26, and the second moving body plate 28 are regulated so as to be prevented from excessively separating away from one another.

A third magnet 66 having a plate shape is fixed, with a plate surface thereof facing the Y direction, to an outer surface of the second moving body plate 28 on the +Y side opposite to the side on which the first magnet 52 is provided. The third magnet 66 includes two segments located on the upper side and the lower side in the Z direction, and an S pole and an N pole are provided on respective plate surfaces and are arranged such that the polarities are reversed on the upper side and the lower side.

As illustrated in FIG. 1, the fixed body 16 includes a second frame member 68, a third magnetic member 70, a first coil 72, a second coil 74, a third coil 76, and a flexible printed board 78. The second frame member 68 includes a base 80 and a second cover 82. The third magnetic member 70, the first coil 72, the second coil 74, the third coil 76, and the flexible printed board 78 are mounted to the second frame member 68. The base 80 and the second cover 82 are each made of a resin or a non-magnetic metal and have a quadrangular shape as viewed from above in the Z direction. The second cover 82 is fitted to an outer side of the base 80 to form the second frame member 68. The second frame member 68 surrounds the first frame member 22 of the moving body 18. The base 80 and the second cover 82 have through holes 84 and 86, respectively, for allowing light to pass therethrough or allowing the lens 14 to be inserted thereinto.

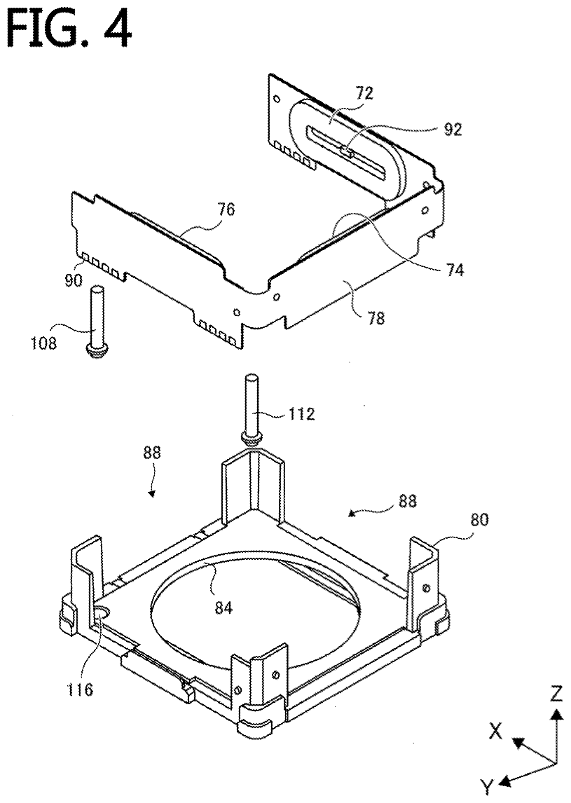

Further, as illustrated in FIG. 1 and FIG. 4, opening portions 88 which are each open on the upper side in the Z direction are formed in four side surfaces of the base 80, respectively. Further, the above-mentioned flexible printed board 78 is arranged in such a manner as to surround three side surfaces of the base 80. That is, the flexible printed board 78 is bent into a substantially U-shape so as to surround the two side surfaces of the base 80 orthogonal to the Y direction and the one side surface (-X side) orthogonal to the X direction.

On an inner side of the flexible printed board 78, the first coil 72 and the third coil 76 are fixed to two surfaces orthogonal to the Y direction, respectively, and the second coil 74 is fixed to one surface orthogonal to the X direction. Terminal portions 90 are provided at a lower portion of the flexible printed board 78 in the Z direction, and supply of a current, output of a signal, and the like are performed via the terminal portions 90.

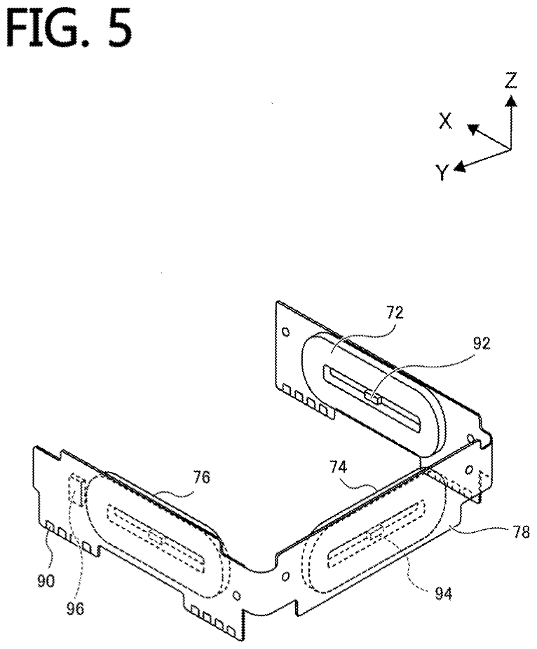

Further, as illustrated in FIG. 5, on the inner side of the flexible printed board 78, a Y-direction position detecting element 92 is arranged at the inside of the first coil 72, and an X-direction position detecting element 94 is arranged at the inside of the second coil 74. A Z-direction position detecting element 96 is arranged at a position adjacent to the third coil 76.

The first coil 72 and the Y-direction position detecting element 92 are arranged in the opening portion 88 in such a manner as to face an inner side of the base 80 and be opposed to the first magnet 52. Similarly, the second coil 74 and the X-direction position detecting element 94 are arranged in the opening portion 88 in such a manner as to be opposed to the second magnet 54. Further, the third coil 76 and the Z-direction position detecting element 96 are arranged in the opening portion 88 in such a manner as to be opposed to the third magnet 66.

Further, as illustrated in FIG. 1, on an outer side of the portion of the flexible printed board 78 to which the third coil 76 is fixed, a third magnetic member 70 made of a magnetic material is arranged parallel to the third coil 76. The third magnetic member 70 is fixed to the side surface of the base 80 in a close contact state through intermediation of the flexible printed board 78. The third magnetic member 70 is opposed to the third magnet 66 with the flexible printed board 78 and the third coil 76 sandwiched between the third magnetic member 70.

A magnetic flux from the third magnet 66 flows through the third magnetic member 70, thereby generating an attraction force between the third magnet 66 and the third magnetic member 70. Therefore, an attraction force in the Y direction with respect to the fixed body 16 acts on the moving body 18.

The third magnetic member 70 has two separated openings 100 and 100, which are two openings separated in the X direction by a coupling portion 98 extending in the Z direction. The coupling portion 98 may extend in the Y direction. In this case, the separated openings 100 and 100 are two openings separated in the Z direction. The third magnetic member 70 is formed of a stainless steel having magnetism or is formed of a plated iron. With the separated openings 100 and 100 formed in the third magnetic member 70, the attraction force generated between the third magnet 66 and the third magnetic member 70 can be adjusted to a desired intensity. That is, the attraction force generated between the third magnet 66 and the third magnetic member 70 can be weakened relative to a driving force of the third coil 76 and the third magnet 66 in the Z direction. With this, the driving force required for the movement in the Z direction can be reduced, and damage on an optical axis-direction guide mechanism 102, which is to be described later, caused by impact from an outside can be reduced.

As illustrated in FIG. 1, the moving body 18 is supported by the optical axis-direction guide mechanism 102 so as to be movable in the Z direction relative to the fixed body 16. That is, the optical axis-direction guide mechanism 102 guides the first frame member 22 in such a manner that the first frame member 22 is freely movable in the Z direction relative to the second frame member 68. That is, with such a configuration, the lens support 20 is guided, together with the first frame member 22, in such a manner as to be freely movable in the optical axis direction. The optical axis-direction guide mechanism 102 includes a third guide mechanism 104 and a fourth guide mechanism 106. The third guide mechanism 104 includes a +X side guide shaft 108 and a +X side guide hole 110. The +X side guide shaft 108 is provided to the second frame member 68. The +X side guide hole 110 is formed in the moving body 18 and accommodates the +X side guide shaft 108. The fourth guide mechanism 106 includes a −X side guide shaft 112 and a −X side guide groove 114. The −X side guide shaft 112 is provided to the second frame member 68. The −X side guide groove 114 is formed in the moving body 18.

In this embodiment, the +X side guide shaft 108 and the −X side guide shaft 112 have a columnar shape extending in the Z direction and are made of, for example, a ceramic, a metal, or a resin. The +X side guide shaft 108 and the −X side guide shaft 112 are arranged in the vicinity of corner portions of the base 80 on an inner side of the side surface on which the third coil 76 is arranged. The +X side guide shaft 108 and the −X side guide shaft 112 have a circular shape in a cross section taken along the X-Y direction, but may only partially have a circular shape or an elliptical shape. A polygonal shape such as a quadrangular shape may also be adopted.

In a bottom surface portion around the through hole 84 of the base 80, in the vicinity of corner portions of the side surface on which the third coil 76 is arranged, there are provided lower fixing portions 116 and 116 each having a cylindrical insertion groove. Lower ends of the +X side guide shaft 108 and the −X side guide shaft 112 are inserted into and fixed to the lower fixing portions 116 and 116, respectively. Further, upper fixing portions 118 and 118 bent toward the Y direction are formed at an upper end of the third magnetic member 70, specifically, at both ends of the third magnetic member 70 in the X direction. Each upper fixing portion 118 has an insertion hole 120. Upper ends of the +X side guide shaft 108 and the −X side guide shaft 112 are inserted into and fixed to the insertion holes 120 and 120. With this, the +X side guide shaft 108 and the −X side guide shaft 112 are fixed to the base 80. The third magnetic member 70 has also a function to support the +X side guide shaft 108 and the −X side guide shaft 112. Therefore, the number of components can be reduced as compared to a case of using separate components, and the +X side guide shaft 108 and the −X side guide shaft 112 can be stably supported.

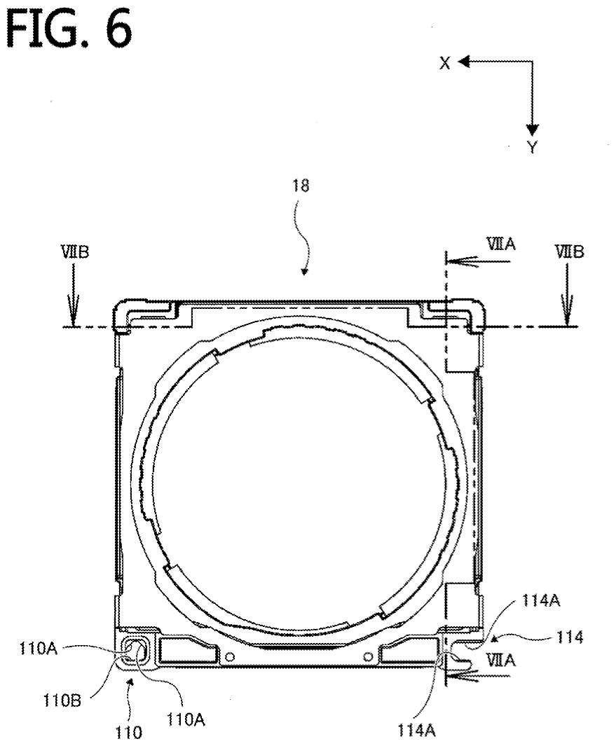

As illustrated in FIG. 2 and FIG. 6, the +X side guide hole 110 is formed as a hollow through hole passing through the second moving body plate 28 from an upper surface to a lower surface in the Z direction. Further, the −X side guide groove 114 is formed as a groove extending in such a manner as to pass through the second moving body plate 28 from the upper surface to the lower surface in the Z direction and being open outward in the −X direction.

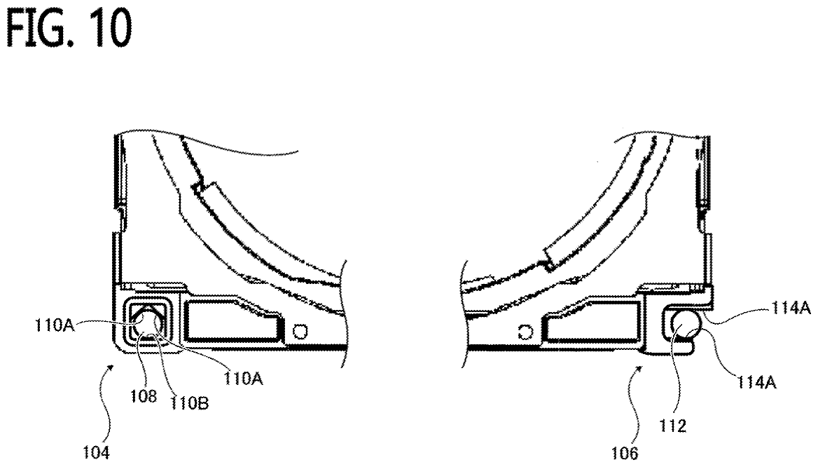

As illustrated in FIG. 6 and FIG. 10, a sectional shape of the +X side guide hole 110 in the X-Y plane on the −Y side is a V-shape that is open toward the +Y side being the fixed body side, and a sectional shape on the +Y side is a rectangular shape. The sectional shape on the +Y side may be a semicircular shape.

The attraction force generated between the third magnet 66 and the third magnetic member 70 mounted to the moving body 18 causes the moving body 18 to be attracted in the +Y direction. Thus, at least guide surfaces 110A and 110A forming a V-shape on the −Y side of the +X side guide hole 110 are brought into line contact with an outer surface of the +X side guide shaft 108 at two positions when viewed from the Z direction. With this, positioning of the moving body 18 with respect to the fixed body 16 in the X direction and the Y direction can be accurately performed. It is preferred that the square-shaped portion of the +X side guide hole 110 and the outer surface of the +X side guide shaft 108 have a slight gap defined therebetween so as to be prevented from being brought into line contact with each other, but the line contact is also adoptable.

Further, the −X side guide groove 114 is formed of two wall surfaces which are opposed to each other in the Y direction in the cross section taken along the X-Y plane. The two wall surfaces have protruding portions 114A and 114A which protrude in a curved surface shape in the Y direction. As illustrated in FIG. 10, at least the center of the protruding portion 114A on the −Y side is brought into contact with the outer surface of the −X side guide shaft 112. That is, the -X side guide groove 114 and the −X side guide shaft 112 are brought into point contact with each other at least at one point, which causes a frictional resistance to be small. It is preferred that the protruding portion 114A on the +Y side and the outer surface of the −X side guide shaft 112 have a slight gap defined therebetween so as to be prevented from being brought into point contact with each other, but the point contact is also adoptable. As described above, the moving body 18 is pressed by the +X side guide shaft 108 and the −X side guide shaft 112 with a magnetic force, and hence is not inclined with respect to the +X side guide shaft 108 and the −X side guide shaft 112. Further, when the lens 14 is larger, the weight of the moving body 18 having the lens 14 mounted thereto is also larger. In this case, in the related art, it is required that a required attraction force given by the magnetic force be set larger. As a result, a frictional force increases, and it is required to increase the driving force by a magnitude corresponding to the increase in weight of the lens or larger. However, in this embodiment, there is given the guide shaft structure. Therefore, it is not required to increase the required attraction force given by the magnetic force, and the driving force may also be small.

In the lens driving device 12 described above, the first magnet 52 and the first coil 72 form a driving mechanism configured to move the lens support 20 in the Y direction relative to the second moving body plate 28. With energization to the first coil 72, a current flows through the first coil 72 in the X direction. The first magnet 52 opposed to the first coil 72 generates a magnetic flux containing a component in the Z direction, and hence a Lorentz force acts on the first coil 72 in the Y direction. The first coil 72 is fixed to the base 80, and hence a reaction force acting on the first magnet 52 serves as a driving force for the lens support 20. The lens support 20 is guided by the second guide mechanism 42 to move in the Y direction.

After the lens support 20 moves in the Y direction, the energization to the first coil 72 is stopped. Then, the attraction force between the first magnet 52 and the first magnetic member 56, the attraction force between the second magnet 54 and the second magnetic member 58, the friction between the lower guide protrusions 44 and the lower guide grooves 46, and the friction between the upper guide protrusions 48 and the upper guide grooves 50 cause the lens support 20 to stop at a position corresponding to the timing of stopping the energization to the first coil 72.

Further, the second magnet 54 and the second coil 74 form a driving mechanism configured to move the lens support 20, together with the first moving body plate 26, in the X direction relative to the second moving body plate 28. With energization to the second coil 74, a current flows through the second coil 74 in the Y direction. The second magnet 54 opposed to the second coil 74 generates a magnetic flux containing a component in the Z direction, and hence a Lorentz force acts on the second coil 74 in the X direction. The second coil 74 is fixed to the base 80, and hence a reaction force acting on the second magnet 54 serves as a driving force for the lens support 20 and the first moving body plate 26. The lens support 20 and the first moving body plate 26 are guided by the first guide mechanism 40 to move in the X direction.

After the lens support 20 and the first moving body plate 26 move in the X direction, the energization to the second coil 74 is stopped. Then, the attraction force between the first magnet 52 and the first magnetic member 56, the attraction force between the second magnet 54 and the second magnetic member 58, the friction between the lower guide protrusions 44 and the lower guide grooves 46, and the friction between the upper guide protrusions 48 and the upper guide grooves 50 cause the lens support 20, together with the first moving body plate 26, to stop at a position corresponding to the timing of stopping the energization to the second coil 74.

The third magnet 66, the third coil 76, and the third magnetic member 70 form a driving mechanism configured to move the moving body 18 in the optical axis direction relative to the fixed body 16. With energization to the third coil 76, a current flows through the third coil 76 in the X direction. The third magnet 66 opposed to the third coil 76 generates a magnetic flux containing a component in the Y direction, and hence a Lorentz force acts on the third coil 76 in the Z direction. The third coil 76 is fixed to the base 80, and hence a reaction force acting on the third magnet 66 serves as a driving force for the moving body 18. The moving body 18 is guided by the optical axis-direction guide mechanism 102 to move in the Z direction. That is, the lens support 20 moves in the optical axis direction.

When the energization to the third coil 76 is stopped after the moving body 18 moves in the Z direction, the attraction force between the third magnet 66 and the third magnetic member 70, the friction between the +X side guide shaft 108 and the +X side guide hole 110, and the friction between the −X side guide shaft 112 and the −X side guide groove 114 cause the lens support 20 included in the moving body 18 to stop at a position corresponding to the timing of stopping the energization to the third coil.

In this case, it is assumed that the camera device 10 receives impact in the Y direction. The +X side guide shaft 108 and the +X side guide hole 110 may separate away from each other by a small distance and immediately return to the original position, and the −X side guide shaft 112 and the −X side guide groove 114 may separate away from each other by a small distance and immediately return to the original position. Therefore, damage is extremely small. The lower guide protrusions 49A and 44B and the lower guide grooves 46A and 46B keep a contact state therebetween, and the upper guide protrusions 48A and 48B and the upper guide grooves 50A and 50B keep a contact state therebetween. Therefore, there is substantially no damage.

It is assumed that the camera device 10 receives impact in the X direction. The +X side guide shaft 108 and the +X side guide hole 110 keep a contact state therebetween, and the −X side guide shaft 112 and the −X side guide groove 114 keep a contact state therebetween. The lower guide protrusions 44A and 44B and the lower guide grooves 46A and 46B keep a contact state therebetween, and the upper guide protrusions 48A and 48B and the upper guide grooves 50A and 50B keep a contact state therebetween. Therefore, there is substantially no damage.

It is assumed that the camera device 10 receives impact in the Z direction. The +X side guide shaft 108 and the +X side guide hole 110 keep a contact state therebetween, and the −X side guide shaft 112 and the −X side guide groove 114 keep a contact state therebetween. Therefore, there is substantially no damage. The lower guide protrusions 44A and 44B and the lower guide grooves 46A and 46B may separate away from each other by a small distance and immediately return to the original position, and are held in the line contact state or the surface contact state, and the upper guide protrusions 48A and 48B and the upper guide grooves 50A and 50B may separate away from each other by a small distance and immediately return to the original position, and are held in the line contact state or the surface contact state. Therefore, there is substantially no damage.

As described above, even when the camera device 10 receives the impact from any direction, in the lens driving device 12 according to this embodiment, the damage is extremely small, or there is substantially no damage. Thus, smooth movement of the lens support 20 in the X, Y, and Z directions can be ensured.

In the embodiment described above, description has been made of the example in which the lower guide protrusions 44 and the upper guide protrusions 48 are provided to the first moving body plate 26 and in which the lower guide grooves 46 and the upper guide grooves 50 are respectively formed in the second moving body plate 28 and the lens support 20, which are opposed to the lower guide protrusions 44 and the upper guide protrusions 48. However, the protrusions and the grooves may be replaced with each other. That is, the guide grooves may be formed in the upper and lower surfaces of the first moving body plate 26, and the guide protrusions may be formed on the second moving body plate 28 and the lens support 20 in such a manner as to be opposed to the guide grooves formed in the upper and lower surfaces of the first moving body plate 26. Alternatively, the protrusions and the grooves may be replaced with each other only on the upper side or only on the lower side.

Further, in the embodiment described above, description has been made of the example in which the first coil 72, the second coil 74, the third coil 76, and the third magnetic member 70 are mounted to the fixed body 12 and in which the first magnet 52, the second magnet 54, and the third magnet 66 are mounted to the moving body 18. However, the first coil 72, the second coil 74, the third coil 76, and the third magnetic member 70 may be mounted to the moving body 18, and the first magnet 52, the second magnet 54, and the third magnet 66 may be mounted to the fixed body 12.

The above-mentioned lens support 20 is further described.

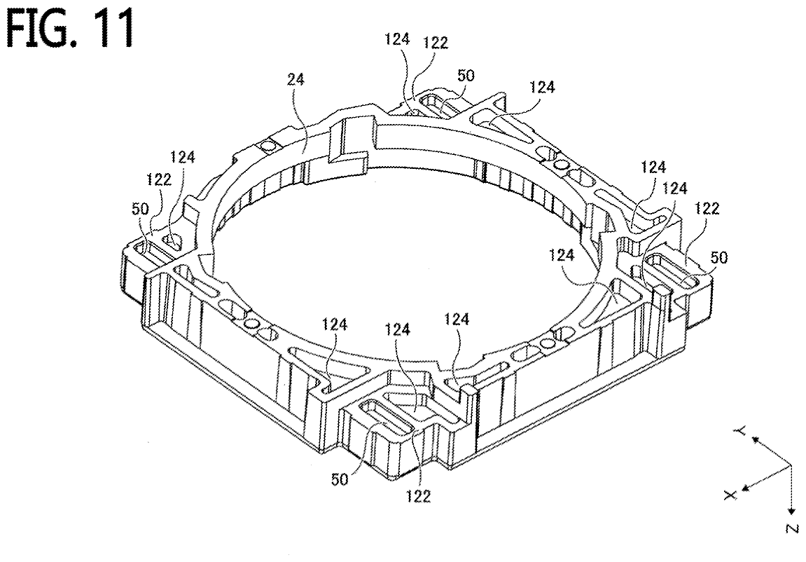

As illustrated in FIG. 11, at the four corner portions of the lens support 20, flat surface portions 122 are formed on an upper side by one step from a lower surface portion of the main body portion. The flat surface portions 122 have the above-mentioned upper guide grooves 50 formed in such a manner as to recess upward from the flat surface portions 122.

Further, the flat surface portions 122 have dummy recess portions 124, which are located in the vicinity of the upper guide grooves 50 and are formed in such a manner as to recess upward from the flat surface portions 122. The dummy recess portions 124 are formed in order to reduce the amount of deformation of the upper guide grooves 50 when the lens support 20 is molded with a small thickness.

The dummy recess portions 124 are formed not only in the flat surface portions 122 but also in the main body portion of the lens support 20. A height of the bottom portions of the dummy recess portions 124 is approximately equal to a height of the bottom portions of the upper guide grooves 50. That is, a distance from the flat surface portions 122 to the bottom portions of the upper guide grooves 50 and a distance from the flat surface portions 122 to the bottom portions of the dummy recess portions 124 are approximately equal to each other. Regarding the dummy recess portions 124 formed in the main body portion, similarly, a height of the bottom portions of the dummy recess portions 124 is approximately equal to a height of the bottom portions of the upper guide grooves 50.

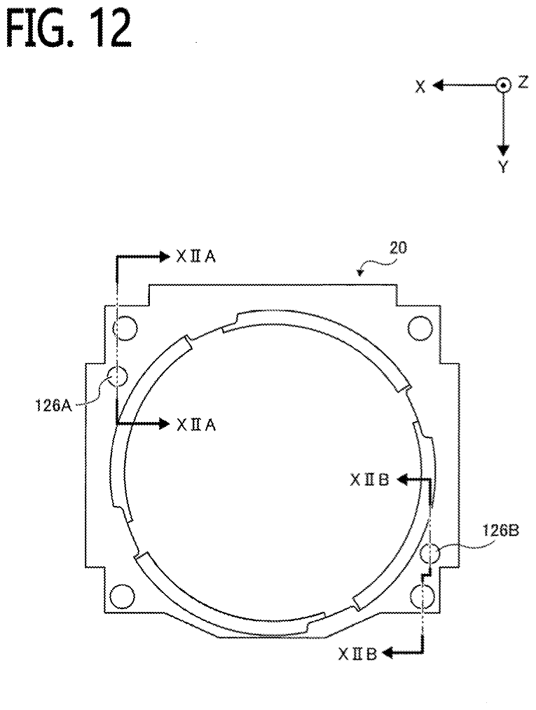

As mentioned above, the lens support 20 is obtained by molding a resin. As illustrated in FIG. 12, the lens support 20 has two marks 126A and 126B of material injection ports located at positions in point symmetry. The marks 126A and 126B of material injection ports are formed at positions which do not overlap the upper guide grooves 50 in the Z direction but overlap the dummy recess portions 124. Further, the marks 126A and 126B of material injection ports are formed on the depth side of the dummy recess portions 124 in the Y direction. The marks 126A and 126B of material injection ports are formed in such a manner as to recess with respect to peripheries thereof.

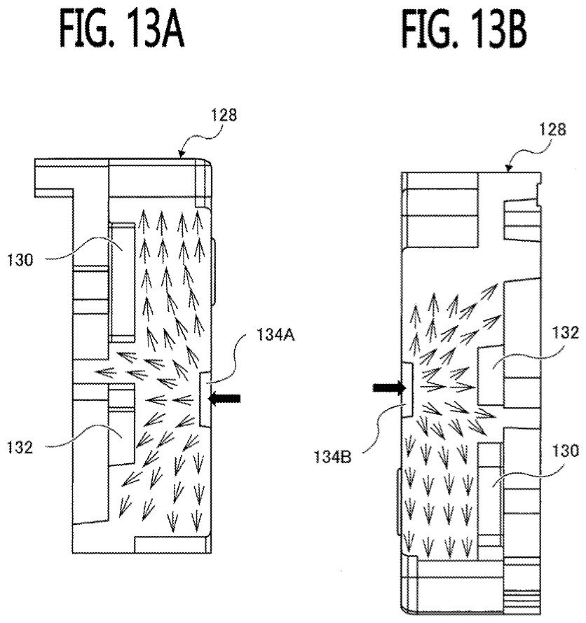

FIG. 13A and FIG. 13E show a state of forming the lens support 20. A lens-support forming mold 128 includes guide-groove forming portions 130 and dummy-recess-portion forming portions 132. Heights of the guide-groove forming portions 130 and the dummy-recess-portion forming portions 132 are approximately equal to each other so that heights of the bottom portions of the upper guide grooves 50 and the dummy recess portions 124 become approximately equal to each other.

Further, the lens-support forming mold 128 has material injection ports 134A and 134B. The material injection ports 134A and 134B are formed in such a manner as to be opposed to the dummy-recess-portion forming portions 132. The mark 126A of a material injection port corresponds to the material injection port 134A, and the mark 126B of a material injection port corresponds to the material injection port 134B.

In order to form the lens support 20, as illustrated in FIG. 13A and FIG. 13B, when a resin is injected into the lens-support forming mold 128 through the material injection ports 134A and 1348, it is expected that the resin flows as indicated by the arrows. As the direction of the arrows on the guide-groove forming portion 130 is closer to a state of being parallel to the upper surface of the guide-groove forming portion 130, a flow of the resin is smooth, and recesses and protrusions are less liable to be formed on slide surfaces of the upper guide grooves 50. Here, as mentioned above, the heights of the guide-groove forming portions 130 and the dummy-recess-portion forming portions 132 are approximately equal to each other. Therefore, the dummy-recess-portion forming portions 132 are less liable to hinder the flow of the resin, and the resin smoothly flows toward the depth side around the guide-groove forming portions 130. Therefore, formation of corrugated recesses and protrusions on the slide surfaces of the upper guide grooves 50 can be prevented, thereby being capable of ensuring stable and smooth movement of the lens support 20.

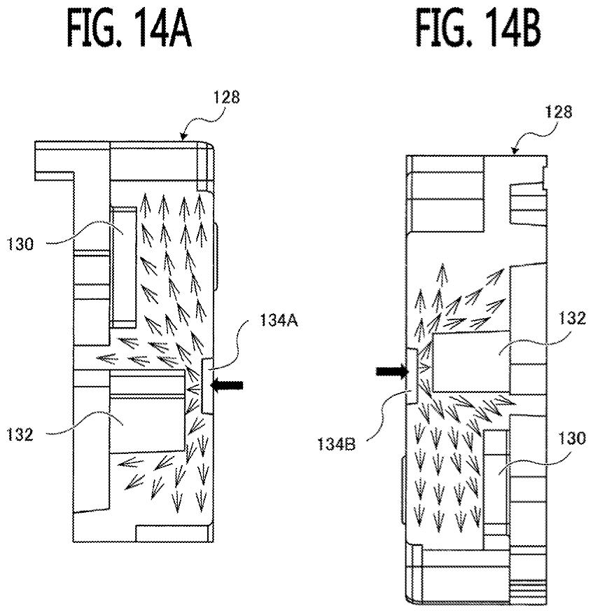

Meanwhile, when the heights of the bottom portions of the dummy recess portions 124 are set excessively higher than the heights of the bottom portions of the upper guide grooves 50, as in another embodiment illustrated in FIG. 14A and FIG. 14B, the resin having been injected into the lens-support forming mold 128 through the material injection ports 134A and 134B immediately hits the dummy-recess-portion forming portions 132, with the result that the smooth flow around the guide-groove forming portions 130 is hindered by the dummy-recess-portion forming portions 132. Therefore, as a result of forming corrugations around the guide-groove forming portions 130 toward the depth side and performing formation, the corrugated recesses and protrusions are disadvantageously formed on the slide surfaces of the upper guide grooves 50.

In the another embodiment, the heights of the bottom portions of the dummy recess portions 124 are set to be excessively higher than the heights of the bottom portions of the upper guide grooves 50. Therefore, the corrugated recesses and protrusions are formed on the slide surfaces of the upper guide grooves 50. However, the amount of deformation of the upper guide grooves 50 can be reduced. Therefore, as long as the recesses and protrusions of the slide surfaces of the upper guide groove 50 fall within an allowable range, the bottom portions of the dummy recess portions 124 may be set higher. In FIG. 13A, FIG. 13B, FIG. 14A, and FIG. 14B, two material injection ports 134A and 134B are formed. However, the number of the material injection ports may be one or three or more.

In the embodiments described above, description has been made of the lens driving device 12 used in the camera device 10. However, the present invention is applicable also to other devices.

What is claimed is:

1. A lens driving device, comprising:
a lens support configured to support a lens;
a frame member configured to support the lens support; and
a guide mechanism configured to guide the lens support in such a manner that the lens support is freely movable in a direction orthogonal to an optical axis direction of the lens relative to a predetermined member forming the frame member,
wherein the guide mechanism includes, on each of one side and another side in a direction orthogonal to a moving direction of the lens support:
a guide protrusion which extends along the moving direction of the lens support, and protrudes in the optical axis direction; and
a guide groove formed in such a manner as to recess in the optical axis direction to allow the guide protrusion to be fitted to the guide groove, and
wherein, when viewed from the direction in which the guide protrusion and the guide groove extend, the guide protrusion and the guide groove are brought into line contact with each other at two positions on the one side in the direction orthogonal to the moving direction of the lens support, and are brought into surface contact with each other on the another side.

2. The lens driving device according to claim 1,
wherein the guide mechanism includes:
a first guide mechanism provided on one side in the optical axis direction; and
a second guide mechanism provided on another side in the optical axis direction, and
wherein at least one of the first guide mechanism or the second guide mechanism includes the guide protrusion and the guide groove.

3. The lens driving device according to claim 2,
wherein the guide protrusion and the guide groove of the first guide mechanism extend in a first direction orthogonal to the optical axis direction, and when viewed from the first direction, the guide protrusion and the guide groove are brought into line contact with each other at two positions on one side in a second direction orthogonal to both the optical axis direction and the first direction and are brought into surface contact with each other on another side, and
wherein the guide protrusion and the guide groove of the second guide mechanism extend in the second direction, and when viewed from the second direction, the guide protrusion and the guide groove are brought into line contact with each other at two positions on one side in the first direction and are brought into surface contact with each other on another side.

4. The lens driving device according to claim 1,
wherein, on the side on which the guide protrusion and the guide groove are brought into line contact with each other, when viewed from the direction in which the guide protrusion and the guide groove extend, the guide groove has such a shape that a width of the guide groove decreases toward a groove bottom, and a space is defined between the guide protrusion and the guide groove in a region between the groove bottom and each of the two positions of the line contact, and
wherein, on the side on which the guide protrusion and the guide groove are brought into surface contact with each other, when viewed from the direction in which the guide protrusion and the guide groove extend, the guide groove has, at a groove bottom thereof, a flat surface extending in a direction orthogonal to the direction in which the guide protrusion and the guide groove extend, and the guide protrusion has a flat surface brought into surface contact with the flat surface of the guide groove.

5. The lens driving device according to claim 1,
wherein the lens support has, on the side on which the guide protrusion and the guide groove are brought into line contact with each other, one of a magnet and a magnetic member arranged parallel to the direction in which the guide protrusion and the guide groove extend, and
wherein the frame member has another one of the magnet and the magnetic member arranged in such a manner as to be opposed to the one of the magnet and the magnetic member.

6. The lens driving device according to claim 5, wherein the frame member is configured to move, together with the lens support, in the optical axis direction.

7. A lens driving device, comprising:
a lens support configured to support a lens;
a frame member configured to support the lens support; and
a guide mechanism configured to guide the lens support in such a manner that the lens support is freely movable in a direction orthogonal to an optical axis direction of the lens relative to a predetermined member forming the frame member,
wherein the guide mechanism includes:
a guide protrusion which is formed on the predetermined member, and protrudes in the optical axis direction; and
a guide groove formed in the lens support in such a manner as to recess in the optical axis direction to allow the guide protrusion to be fitted to the guide groove, and
wherein the lens support has, on one surface thereof having the guide groove, a dummy recess portion formed in the vicinity of the guide groove.

8. The lens driving device according to claim 7, wherein a height of a bottom portion of the dummy recess portion is approximately equal to a height of a bottom portion of the guide groove.

9. The lens driving device according to claim 8, wherein, on a surface on a side opposite to the one surface having the guide groove and the dummy recess portion, a mark of a material injection port for forming the lens support is formed at a position of being prevented from overlapping the guide groove in the optical axis direction.

10. The lens driving device according to claim 8, wherein, on a surface on a side opposite to the one surface having the guide groove and the dummy recess portion, a mark of a material injection port for forming the lens support is formed at a position of overlapping the dummy recess portion in the optical axis direction.

11. A camera device, comprising:
the lens driving device of claim 1; and
a lens supported by the lens support.

12. An electronic apparatus, comprising the camera device of claim 11.
